(19) United States
(12) Patent Application Publication
(10) Pub. No.: US 2013/0104461 A1
(43) Pub. Date: May 2, 2013

(54) COATING MATERIAL, COATING AND COATED OBJECT

(71) Applicants: PICODEON LTD OY, Helsinki (FI); CARBODEON LTD OY, Helsinki (FI)

(72) Inventors: Vesa MYLLYMÄKI, Helsinki (FI); Jukka HÄYRYNEN, Helsinki (FI); Mika KAUPPINEN, Siilinjarvi (FI)

(73) Assignees: CARBODEON LTD OY, Helsinki (FI); PICODEON LTD OY, Helsinki (FI)

(21) Appl. No.: 13/621,633

(22) Filed: Sep. 17, 2012

Related U.S. Application Data
(60) Provisional application No. 61/535,447, filed on Sep. 16, 2011.

(51) Int. Cl. C09D 7/12

(52) U.S. Cl. CPC C09D 7/1233
USPC 51/307; 428/698; 428/690; 106/287.2; 524/90

(57) ABSTRACT

A coating material is used for coating a substrate by means of laser ablation. The coating material contains graphitic carbon nitride and a dopant in order to alter the properties of the coating produced as compared to a coating of pure carbon nitride.

### CROSS REFERENCE TO RELATED APPLICATIONS

This non-provisional application claims the benefit of U.S. Provisional Application No. 61/535,447 filed on Sep. 16, 2011. The entire content of the above application is hereby incorporated by reference.

### TECHNICAL FIELD

The invention relates in general to coatings and coating materials to achieve desired properties for a surface of an object. In particular, the invention relates to the use of doped carbon nitride as a coating material and a coating made of such a material and an object coated with it.

### BACKGROUND

It is known to use coating to achieve desired effects regarding the appearance and technical properties of objects. In technical applications, the characteristics of interest of a coating include thickness, transparency or translucency, colour, fluorescence, hardness, homogeneity, surface roughness, compatibility with various substrate materials, adhesion to substrate, diffusion blocking properties, chemical and tribological properties, bio-compatibility, electrical and thermal conductivity as well as suitability for producing a coating in different processes. Typical coating processes include vacuum evaporation, anodising, sputtering, chemical vapour deposition (CVD), atomic layer deposition (ALD), molecular beam epitaxy (MBE) and laser ablation. In the latter, high-powered and extremely short laser pulses hit a target, ablating from it coating material in the form of plasma which hits the substrate to be coated, producing the desired coating.

A known coating material is graphitic carbon nitride C₃N₄₊ₓH_{y} which, at the time of writing, can be obtained e.g. from Carbodeon Ltd Oy, Helsinki, Finland, which markets it under the registered trademark Nicanite®. It has several advantageous properties such as hardness, excellent wear resistance in tribological applications, chemical inertness, good yield, highly controllable coating process, non-toxic raw materials and an environmentally friendly production process.

However, the graphitic carbon nitride does not solve all the problems of coating. For instance, it cannot be used as a fluorescent coating to produce white light with light emitting diodes (LEDs) because its ultraviolet-induced fluorescence is in the 390-450 nm wavelength range, i.e. at the shorter-wave, or blue, end of visible light. Furthermore, there are coating applications where carbon nitride will not produce the desired uniformity or other desired micro-, nano- and/or crystal structure of the surface. A desired transparency or wavelength selectivity are not easily achieved with carbon nitride in coatings of optical components. FIG. 1 shows the measured transmittance of an 800-nm-thick carbon nitride coating for a wavelength area that extends a few hundred nanometres beyond the visible light range in both directions.

There is a wide range of applications which require both high wear resistance and low friction at the same time. Furthermore, a coating is often expected to be easy to clean or dirt repellent. In some applications the coating should also be transparent enough. Typical such applications include displays and casing solutions for electronics products.

Typical dirt repellent, low-friction coatings include polytetrafluoroethylene based coatings in various industrial processing devices and household products. In addition to limited wear resistance the relatively low thermal resistance also limits the use and life span of the products. Exposed to higher temperatures (>250° C.), most polytetrafluoroethylene products decompose thermally, yielding dangerous fluoric compounds in the gaseous state.

### SUMMARY OF THE INVENTION

An objective of the invention is to provide a coating material, coating and a coated object to achieve desired technical properties. In particular, an objective of the invention is to provide a coating material, coating and a coated object that have desired properties in the visible light range: fluorescence, transparency, reflectivity and/or wavelength selectivity, for example. In addition, an objective of the invention is to provide a coating material, coating and a coated object that have a desired hardness and desired hydrophilicity or hydrophobicity. Furthermore, an objective of the invention is to provide a coating material, coating and a coated object that have a desired surface uniformity or other desired micro-, nano- and/or crystal structure. Yet another objective of the invention is to provide a coating material, coating and a coated object in which the coating has desired diffusion blocking properties.

The objectives of the invention are achieved by using doped carbon nitride as the coating material. A significant advantage, from the standpoint of achieving the objects of the invention, can be gained by using laser ablation as the coating method and by using a laser ablation target which has a sufficient density and a sufficiently small grain size.

According to aspects of the invention, there are provided a coating material, a coating, and a coated object.

Graphitic carbon nitride such as Nicanite® is, as its name suggests, graphitic in nature, i.e. its crystal structure is characterised by sp2-type bonds causing the carbon and nitrogen atoms to form planar 2-dimensional structures. Doping of graphitic carbon nitride e.g. with nanodiamonds, boron compounds, hydrogen, fluoropolymer(s) and/or one or more rare earth metals (or alkali metals or alkaline earth metals) will change its properties in a way which can be very surprising and useful.

For example, a carbon nitride coating doped with nanodiamonds has been found to be very hard and a clear shift towards red has been observed in its visible light fluorescence as compared to pure carbon nitride. Doping with boron compounds may produce a coating which is very hard and/or almost completely transparent in the visible light range. Doping with hydrogen relaxes the double bonds between carbon and nitrogen atoms, altering the two-dimensional crystal structure towards a more three-dimensional structure as well as improving the uniformity and the surface quality of the coating. Doping with rare earth metals, alkali metals or alkaline earth metals may produce wavelength selectivity and/or desired fluoresence in the coating.

Doping can be done with a laser ablation target which contains the desired dopant. Another alternative is to bring the dopant into the laser ablation chamber in the form of gas or particles. Alternative number three is to use two or more laser ablation targets for ablating carbon nitride and dopant simultaneously or in turns. These methods are not mutually exclusive but it is possible to simultaneously use a pre-doped target and a gaseous dopant or two targets, one of which is of doped carbon nitride and the other something else or carbon nitride doped in some other way.

The coated object may be a machine tool, optical component, LED component or a fluorescent casing of a LED component, for instance. In the case of a machine tool the hardness, durability and tribological properties of the coating usually come first in importance, but fluorescent properties may have unpredictable advantages in respect of the wear of the tool, for example. In the case of optical components, the optical properties of the coating are important but hardness, for example, is of significant advantage if it can improve the scratch resistance of the optical component. Likewise, in the case of LED components and their casings, the fluorescence is doubtlessly of primary importance amongst the properties of a coating, but hardness and chemical stability, for example, may be highly advantageous if the LED components are used in demanding conditions.

### BRIEF DESCRIPTION OF THE DRAWINGS

The invention is below described in more detail referring to the preferred embodiments presented by way of example and to the accompanying drawings in which

FIG. 1 shows the transmittance of a known carbon nitride coating,

FIG. 2 shows a basic laser ablation setting,

FIG. 3 shows another basic laser ablation setting,

FIG. 4 shows the transmittance of a coating known from the prior art,

FIG. 5 shows the transmittance of a carbon nitride coating doped with a boron compound,

FIG. 6 shows the transmittance of a carbon nitride coating doped with a second boron compound,

FIG. 7 shows the transmittance of a carbon nitride coating doped with a third boron compound,

FIG. 8 shows a FIB-SEM image of a carbon nitride based coating,

FIG. 9 illustrates the percentages of carbon, nitrogen and boron in some materials,

FIG. 10 shows the reflection coefficient of a coating according to an embodiment of the invention,

FIG. 11 shows a LED component,

FIG. 12 shows a second LED component and a casing of a LED component,

FIG. 13 shows an optical element,

FIG. 14 shows a machine tool,

FIG. 15 shows the photoluminescence of powdery carbon nitride,

FIG. 16 shows the photoluminescence of various nanodiamond doped carbon nitride coatings, and

FIG. 17 shows the photoluminescence of various boron nitride doped carbon nitride coatings.

Like elements in the drawing are denoted by like reference designators.

### DETAILED DESCRIPTION OF EMBODIMENTS OF THE INVENTION

In this description the following terms and expressions are used:

Nicanite® a graphitic carbon nitride, C₃N₄₊ₓH_{y}, manufactured by Carbodeon Ltd Oy

nanodiamond single diamond crystal with a diameter of a few nanometres

fluoropolymer a polymer with one or more fluorine atoms in its monomer; e.g. polytetrafluoroethylene (PTFE)

LED component an electronic component emanating visible or near-visible light and containing a p-n junction that emits radiation in response to a certain kind of electric current flowing through it

LED component casing a cover part usually made of plastic, rubber or glass the purpose of which is to cover the LED component or its p-n junction at least in part and/or change the wavelength and/or spatial distribution of the radiation emitted by the LED component

optical component a device or part thereof usually consisting of one single piece the principal function of which relates to the permeance, reflection, refraction or transmission of visible or near-visible light; e.g. a lense, mirror, prism, surface of a display device or similar

machine tool a means for machining objects or materials in which the cutting edge is meant to penetrate into the substance machined and remove portions therefrom; in this description, also knives and similar cutting blades are considered machine tools.

### Properties of Coating Material

According to an advantageous embodiment of the invention a coating material used for coating a substrate by means of laser ablation contains graphitic carbon nitride and a dopant in order to alter the properties of the coating produced as compared to pure carbon nitride. The density of the coating material in the laser ablation target is at least 70% (advantageously over 80%) of the theoretical density of the coating material, and the grain size of the dopant in the coating material is not more than 30 micrometres.

The theoretical density_{ρtheory} of the material is generally defined as

$${ρ}_{theory} = \frac{{N}_{0} A}{{V}_{0} {N}_{A}}$$

where N₀ is the number of atoms in the unit cell, A is the atomic weight, V₀ is the volume of the unit cell and N_{A} is the Avogadro's number. The density of the target material must be high enough lest the target disintegrates during the laser ablation. An advantageous method for making a target of sufficient density is called spark plasma sintering (SPS), also known as field assisted sintering technique (FAST). The target can also be made using the hot isostatic pressing (HIP) technique or some other compacting method.

The reason for the requirement on the maximum grain size of the dopant is that when trying to produce plasma of uniform quality (and especially reactive plasma) the constituent components of the coating material must be mixed in the target in such a manner that a laser pulse hitting the target will always ablate both carbon nitride and the dopant(s). In the study that led to the invention it was found that the spot size of the laser pulse (the smallest diameter of the area that the laser pulse hits at the target) usually should not be smaller than 30 micrometres. When the lower limit for the spot size is equal to the upper limit for the dopant grain size of the coating material, one can be certain that no laser pulse will ablate only the dopant from the target.

Carbon Nitride Doped with Nanodiamonds

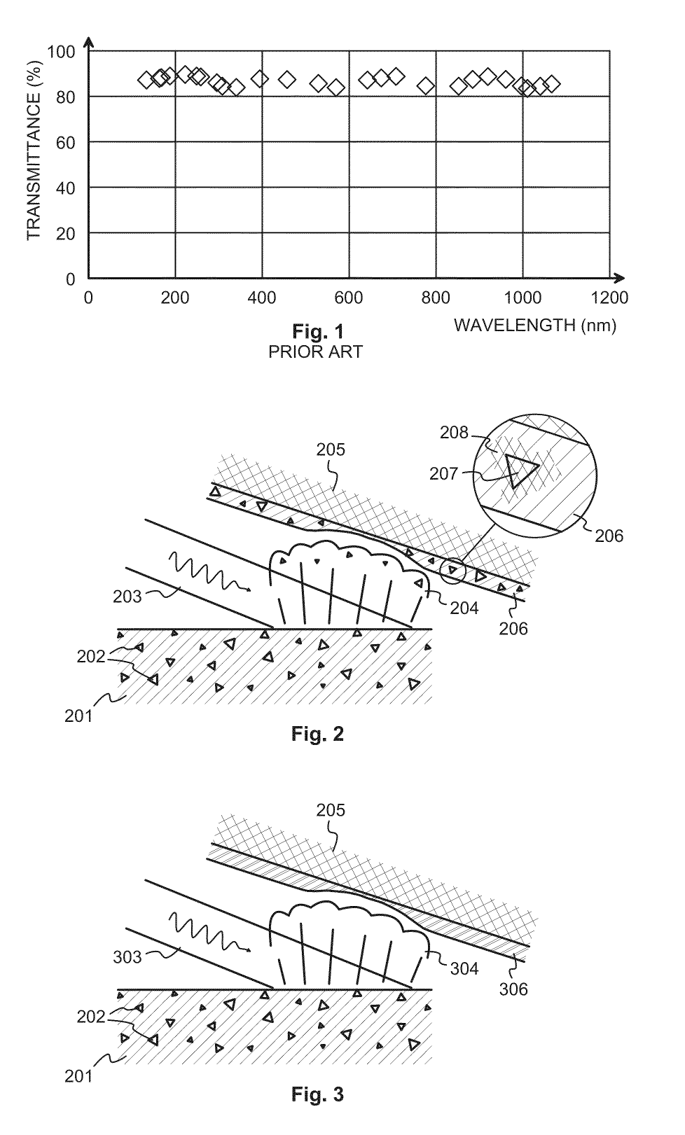

FIG. 2 schematically illustrates the production of a coating by laser ablation involving a carbon nitride target 201 containing nanodiamonds 202 of which there are a few per cent by weight. Such a target can be manufactured for example by compacting a mixture of pulverised graphitic carbon nitride and nanodiamonds. At the time of writing, pulverised graphitic carbon nitride as well as nanodiamonds can be commercially obtained from Carbodeon Ltd Oy, Vantaa, Finland, for example. A pulsed laser beam 203 is directed onto the surface of the target 201 so that target material comes off, producing a so-called plasma plume 204. Some of the target material that came off hits a nearby substrate 205, forming a coating 206 on it. To coat substrate pieces of substantial size the laser beam 203 is scanned along the surface of the target 201. It is also possible to move the target and/or substrate during the coating process in order to coat a larger substrate area.

The nanodiamond content in the target in percentages by weight may be advantageously 1-50%, more advantageously 1-20%, and most advantageously 1-10%. It could be, for example, 2% or 5%. However, coatings can be made with carbon nitride targets that contain a mixture of nanodiamonds and nanographite (nano-sized graphite particles). As FIG. 2 schematically shows, the spot of the ablating laser beam, i.e. the area on the surface of the target onto which the ablating laser beam is directed, has a very large diameter compared to that of a single nanodiamond. The diameter of the spot may be tens of micrometres whereas the diameter of a single nanodiamond is only a few nanometres. If the carbon nitride and nanodiamonds have been uniformly mixed during the manufacture of the target, the target can be considered to have a uniform quality for laser ablation: as regards the composition of the material ablated, it is irrelevant exactly where on the surface of the target the ablating laser pulse is directed at each given moment.

A known type of laser ablation is cold ablation which is characterised in that the duration of a single laser pulse is shorter than a time constant representing the transfer of thermal energy in the target material. In other words, the laser pulse, within the area of the spot, delivers energy to the target material for a time so short that the energy delivered has no time to proceed deeper into the target material by means of thermal interaction. In practice, all target material in the spot area from the surface of the spot down to so-called ablation depth will come off as plasma, leaving a crater that has the size of the spot, has a depth that equals the ablation depth, and has a very uniform base. In cold ablation the length of the laser pulse is measured in pico-, femto- or attoseconds. A nanosecond laser cannot be used for cold ablation because a pulse length measured in nanoseconds has such a magnitude that a significant portion of the energy of the pulse is absorbed in the target material as thermal energy.

It is known that cold ablation can be used to produce high-quality plasma, when the quality of the plasma is measured by the absence of droplets and particles: the transfer of energy from laser pulse energy into energy of the ablated target material is so sudden and limited to so small amount of target material that it breaks down the ablated material into atomic plasma. Therefore, it can be considered surprising that there are regions of process parameters (especially power density of laser beam directed onto target surface) where the nanodiamonds, which are used as a dopant in carbon nitride, will not break down, at least not completely, in cold ablation but can be found in the coating produced, which has been proved through optical measurements.

When making a carbon nitride target doped with nanodiamonds, it is also possible to produce intentional variations in the uniformity of quality in the target. For example, the distribution of nanodiamonds in the carbon nitride can be made dependent on the depth, i.e. the nanodiamond content in the target may be different at different depths from the surface of the target. It is known that in laser ablation the stoichiometry is well preserved in the coating material, i.e. the relative portions of the different constituent components in the coating are very similar to those in the target. So, if the target is ablated one layer at a time and the relative amount of the dopant (here: nanodiamonds) changes between layers, a corresponding relative variation in the nanodiamond content can be produced in the coating as well.

Compared to pure carbon nitride, a carbon nitride doped with nanodiamonds has a lower ablation threshold. In other words, the energy density of the laser pulse required in the area of the spot for the target material to come off is lower. In one experiment, a 9.8-watt laser power was used for the ablation of a pure carbon nitride target, while the same ablation—without changing any other process parameter—was achieved with 0.8-watt laser power for a nano-diamond-doped carbon nitride target and with 0.35-watt laser power for a carbon nitride target doped with nanodiamonds and nanographite.

One advantageous property resulting from the lower ablation threshold of a nanodiamond-doped carbon nitride in the production of coating is a good yield: with a relatively low laser power it is possible to produce significant quantities of coating in a short time. One way of benefiting from the lower ablation threshold is to increase the laser spot size, because in spite of the larger spot the laser power hitting the target suffices for a uniform ablation in the whole area of the spot. With a larger spot size it is naturally possible to produce more coating in a shorter time. Thanks to the lower ablation threshold it is also easier to produce a coating of good quality (uniform, hole-free and particle-free), because as the laser power required is low, small inaccuracies in the alignment of the laser or in scanning, for instance, will not very easily result in significant aberrations from uniform quality.

Coatings according to the invention produced from nanodiamond-doped carbon nitride are very hard. A hardness even exceeding 10H has been measured in the pencil hardness test. The partial enlargement shown in FIG. 2 provides one explanation for this. A nanodiamond that has ended up in the coating 206 is designated with a reference number 207 to distinguish it from nanodiamonds 202 in the target material. Sp3-type bonds between carbon atoms are typical of the crystal structure of the nanodiamond 207. As the plasma stripped from the target by the laser beam begins to cool down, the nanodiamonds (or the sp3-crystalline regions in the plasma that originate from the nanodiamonds in the target material; the nanodiamonds from the target material do not necessarily appear in the plasma in their original intact form) act as nucleation centres. In the coating 206, a region of carbon nitride will be formed around these where sp3-type bonds are more common than in carbon nitride in general. In the partial enlargement of FIG. 2 this region is designated as 208.

FIG. 3 schematically shows the production of another coating by laser ablating a carbon nitride target 201 which in this case, too, is shown as containing nanodiamonds 202 as a dopant. More generally, a target 201 is used which contains at least carbon nitride and which may contain a dopant or dopants. In this case the power density of the cold ablation laser 303 is so high that a significant portion of the plume is reactive in nature. In other words, a significant quantity of the constituent components of the plasma have so much energy that they are able to seek the most advantageous (and most stable) states as regards potential energy.

Strictly speaking, the coating 306 formed on the substrate 205 in the arrangement of FIG. 3 does not necessarily consist of the same material(s) as the target 201 but the phenomena occurring in the reactive plasma may even produce molecular structures which are as yet completely unknown. This would seem to be suggested by the nearly perfect permeance to visible light achieved with coatings produced from a carbon nitride target doped with boron compounds, discussed in more detail later on.

The embodiment shown in FIG. 3 is also characterised by having the advantageous properties of cold ablation such as the fact that within the spot area, from the target surface down to ablation depth, all target material comes off and is converted into plasma. We can thus safely assume that the mass fractions of the different elements in the coating 306 are the same as in the target 201 unless a gaseous medium was added in the ablation chamber and took part in the phenomena occurring in the reactive plasma. However, it is relatively difficult to examine the structure of the coating 306 down to the level of atoms and their bonds, so the coatings produced in this way are often defined according to the technique used (so-called product-by-process).

All in all, it can be said that the nanodiamonds used as dopants can produce not only nucleation centres but also atomic carbon in the coating. The structure will then have a certain surplus of carbon compared to the C₃N₄ structure. Chemical processes may take place in the plasma whereby some of the C3N3 ring structures may become C4N2 or C5N structures, for instance. Additionally, some of the nitrogen bridges that link the ring structures may be replaced by carbon.

Ultraviolet irradiation at a wavelength of 366 nanometres will induce photoluminescent radiation in the 390-450-nanometre range from a pure, sp2-configured carbon nitride coating (see e.g. Jianjun Wang, Dale R. Miller, Edward G. Gillan: “Photoluminescent carbon nitride films grown by vapor transport of carbon nitride powders*, CHEM. COMMUN., 2002, 2258-2259). However, a coating produced by cold ablation of nanodiamond-doped carbon nitride target on a steel surface will generate photoluminescent radiation with a clear redder component so that the photoluminescence can be considered white. The red component is the result of nanodiamonds being preserved in the coating and/or of the fact that the energetic nature of the plasma has given rise to novel bond structures producing red fluorescent light.

The presence of the redder component in the photoluminescence is observed at least when using detonation nanodiamonds as the dopant in the carbon nitride. The detonation takes place in a chamber charged with a mixture of trinitrotoluene (TNT) and cyclotrimethylene-trinitramine (RDX). As the explosives contain nitrogen, the nanodiamonds will contain it as well, so their use as a dopant in carbon nitride will add to the overall nitrogen content. A relatively high nitrogen content in a doped carbon nitride coating increases the transparency of the coating, i.e. its transmittance at visible light wavelengths.

A particularly advantageous property of the photoluminescence of a nanodiamond-doped carbon nitride coating is its good stability. It has been found that the photoluminescence of a coating made of carbon nitride remains the same for at least years and there is nothing to indicate that a carbon nitride coating doped with nanodiamonds should have a less stable photoluminescence.

Carbon Nitride Doped with Boron Compounds(s)

Transmissivity of a coating cold-ablated from pure carbon nitride is typically 90-92% at visible light wavelengths and the coatings are either clear or faintly yellowish. Surprisingly, however, it has been found that the addition of boron nitride or carbide in a carbon nitride target may produce a coating which is very transparent at visible light wavelengths up to coating thicknesses of even one micrometre even though boron nitride, for example, is white and opaque to visible light in all its states. This increase in transmissivity suggests that nitrogen-rich CBN composite materials of a completely new type are being generated through molecular re-structuring in the plasma.

Surprisingly, it is possible to make CBN composite films such that they are hard and wear-resistant as well as elastic at the same time.

Carbon nitride coatings doped with boron compound(s) are useful also because of their diffusion blocking properties. Generally, coatings acting as diffusion barriers should have a structure so dense that they block the passage of both gases and liquids, preventing these from coming into contact with the object protected. In practice this means that the coatings must not contain any pinholes or crystal structure interfaces. An optimal diffusion barrier should therefore have an amorphous structure. Furthermore, typical requirements for industrial diffusion barrier coatings related to electronics, for instance, include high transparency, adjustable refractive index, dielectricity, chemical inertness and good heat resistance. In addition, if such coatings are applied to polymer substrates, the coatings should be elastic so that they do not come off under external pressure.

Application of nitrogen-rich carbon-boron-nitrogen materials (or nitrogen-rich CBN materials) in coatings is not known from the prior art. Typically, the lack of stoichiometric manufacturing methods has prevented the production of coatings from nitrogen-rich forms of materials. FIG. 4 illustrates an example of the prior art, showing transmittance results cited for material BC_{0.24}N_{0.24} in Douglas B Chrisey, Ruqiang Bao, Zijie Yan: “Transitions of Boron Carbide to B—C—N Thin Film”, Mater.Res.Soc.Symp.Proc., Vol 1204, 2010. Curve 401 represents the transmittance of a 390-nanometre-thick coating made of the above-mentioned B—C—N material, and curve 402 represents the transmittance of a 293-nanometre-thick boron carbide film.

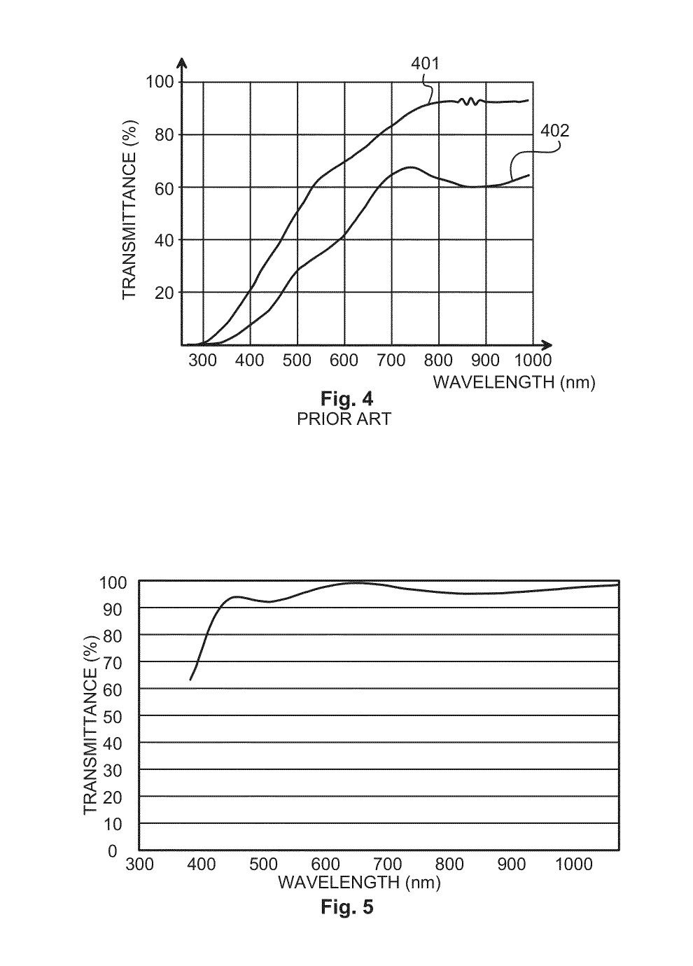

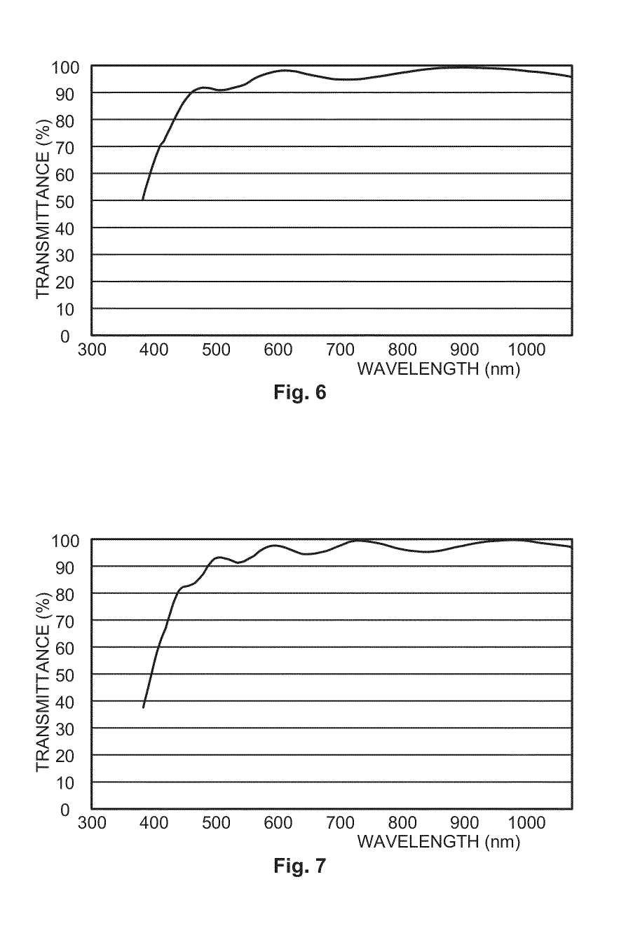

Another prior-art publication is Q. Yang, C. B. Wang, S. Zhang, D. M. Zhang, Q. Shen, L. M. Zhang: “Effect of nitrogen pressure on structure and optical properties of pulsed laser deposited BCN thin films”, Surface & Coatings Technology 204 (2010) 1863-1867, describing the use of a nanosecond laser in producing boron-based coatings through ablation. According to this publication, the maximum nitrogen content achievable with the pulsed laser deposition (PLD) technique is limited to 26% and the transmittance of the coatings produced to about 80% in the visible light range. Additionally the publication teaches that when a nitrogen atmosphere is used in the PLD, part of the boron in the target will not end up in the coating produced. In other words, the method is not stoichiometric according to the publication. FIGS. 5, 6 and 7 show measured transmittances of carbon nitride coatings doped with boron nitride for three example cases of different coatings according to an embodiment of the invention. The coatings were produced on borosilicate glass and the effects of the transmittance of the latter have been eliminated from the measurement results shown in FIGS. 5, 6 and 7. The properties of the coatings are shown in the table below.

| | | | | Scanning | |
|---|---|---|---|---|---|
| | n | Thickness | | speed | Pressure |
| FIG. | (632.8 nm) | nm | Hardness | mm/s | mbar |
| 5 | 1.73 | 380 | 8H | 40 | 4.8 · 10⁻⁶ |
| 6 | 1.70 | 450 | N/A | 35 | 9.0 · 10⁻⁶ |
| 7 | 1.73 | 1200 | 8H | 30 | 9.0 · 10⁻⁶ |

The second column in the table indicates the refractive index of the coating at a wavelength of 632.8 nm, the third column the thickness of the coating, the fourth column the hardness of the coating on the pencil hardness scale, the fifth column the scanning speed of the laser beam spot on the surface of the target, and the sixth column the pressure in the chamber in which the coating was made. In the target, the ratio of carbon nitride to boron nitride was 9:1 in atom fractions and the target was kept at room temperature during ablation (i.e. no special target heating was used in the ablation). In each case the ablation lasted for 15 minutes, so the differences in coating thickness are due to variations in the scanning speed and pressure.

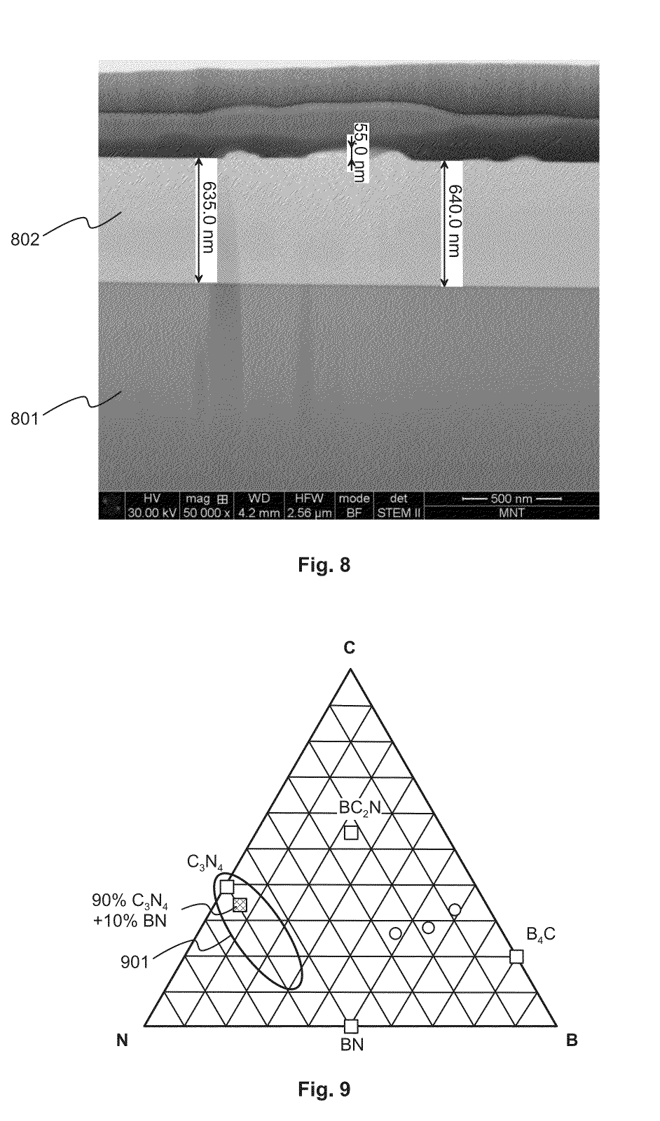

FIG. 8 shows a FIB-SEM (Focused Ion Beam—Scanning Electron Microscope) image of a section of a silicon substrate 801 coated with 635-640-nanometre-thick coating 802. The coating is produced by means of cold ablation from a target mainly consisting of carbon nitride. The dark belts above the coating 802 are due to silver plating which is necessary because of the imaging method used. The Figure shows that the coating 802 amorphous throughout, i.e. no grain boundaries can be seen at all. In addition the coating 802 is very uniform and no pinholes at all were detected even outside the area shown in FIG. 8 which is a few micrometres wide.

CBN composite coatings produced in this way can be used as transparent optical coatings with good mechanical properties (wear resistance, hardness) and a low dielectric constant. They also act as diffusion barriers, blocking both gases and liquids, so they can be used for protecting electronic products intended for industrial or household use, for example. Some particularly advantageous uses that benefit from the diffusion blocking capacity of the CBN coating include organic light emitting diodes (OLEDs), thin film based solar cell solutions, industrial and household display solutions for TVs, computers and mobile phones, and measuring instruments. They can also be used as protective coatings for hard disks. As the CBN coatings produced are elastic as well, they can be advantageously used as functional coatings for polymer based products, too.

Like nanodiamond doping, also boron nitride doping lowers the ablation threshold of carbon nitride. This is very surprising because the ablation threshold of pure boron nitride is higher than that of pure carbon nitride. Experiments have shown that when a coating was produced by cold ablation from pure carbon nitride with a laser power of 25-30 watts and scanning speed of 100 mm/s, the corresponding laser power needed for the production of plasma could be decreased by increasing the boron nitride doping as follows:
2 per cent by weight of boron nitride: laser power 32 W
5 per cent by weight of boron nitride: laser power <10 W
10 per cent by weight of boron nitride: laser power 6 W
25 per cent by weight of boron nitride: laser power 6.5 W.

As its name suggests, boron nitride contains boron and nitrogen. FIG. 9 shows a ternary diagram illustrating the atom fractions of carbon, nitrogen and boron in some materials. White squares indicate boron nitride BN, boron carbide B₄C, BC₂N (or BCCN) known as a superhard material, and pure carbon nitride C₃N₄. White circles indicate materials discussed in the above-mentioned scientific publication by Yang et al: “Effect of nitrogen pressure on structure and optical properties of pulsed laser deposited BCN thin films”. The cross-hatched square indicates a mixture in which the ratio of carbon nitride to boron nitride is 9:1. The ellipse 901 indicates a region in the ternary diagram where interesting coating materials can be found, which materials are different mixtures of carbon nitride and boron nitride.

The measured hardness of 8H of a boron-nitride-doped carbon nitride coating is already as such very high, so this kind of coating can be especially advantageous in optical components that have to endure rough handling without getting scratched. One example of such an optical component is a transparent window or lense on the display of a portable communication device, game device or computer. If, in addition to a boron compound, some other dopant, such as a metal, alkali metal, rare earth metal and/or alkaline earth metal, is added to the carbon nitride material in the target, wavelength selectivity can be introduced in the transmittance spectrum of the coating produced from the target.

An even harder coating can be produced by changing the process parameters. The hardness of CBN coatings according to an embodiment of the invention with thicknesses between 30 nanometres and 1200 nanometres was measured to be over 9H on the pencil hardness scale. In another test batch, 100-500-nanometre-thick CBN coatings were produced on silicon, glass and AISI420 steel, and their wear resistance was tested using the so-called Pin On Disk (POD) test. An aluminium oxide testing head was used and the test consisted of one million cycles. According to the test, CBN coatings which were in accordance with embodiments of the invention suffered, depending on the sample, 30 to 50 times less wear than an uncoated silicon substrate.

The coefficient of friction of a typical CBN coating was measured against aluminium oxide. The relative humidity of air was 30% at the time of the measurement. The measured coefficient of friction was 0.2.

When a boron compound doped carbon nitride coating is produced on a substrate heated to a temperature clearly higher than the room temperature, the coating thus produced will be particularly hard, although the heating of the substrate tends to reduce the transmittance in the visible light wavelengths, or the transparency, of the boron compound doped carbon nitride coating produced on the substrate.

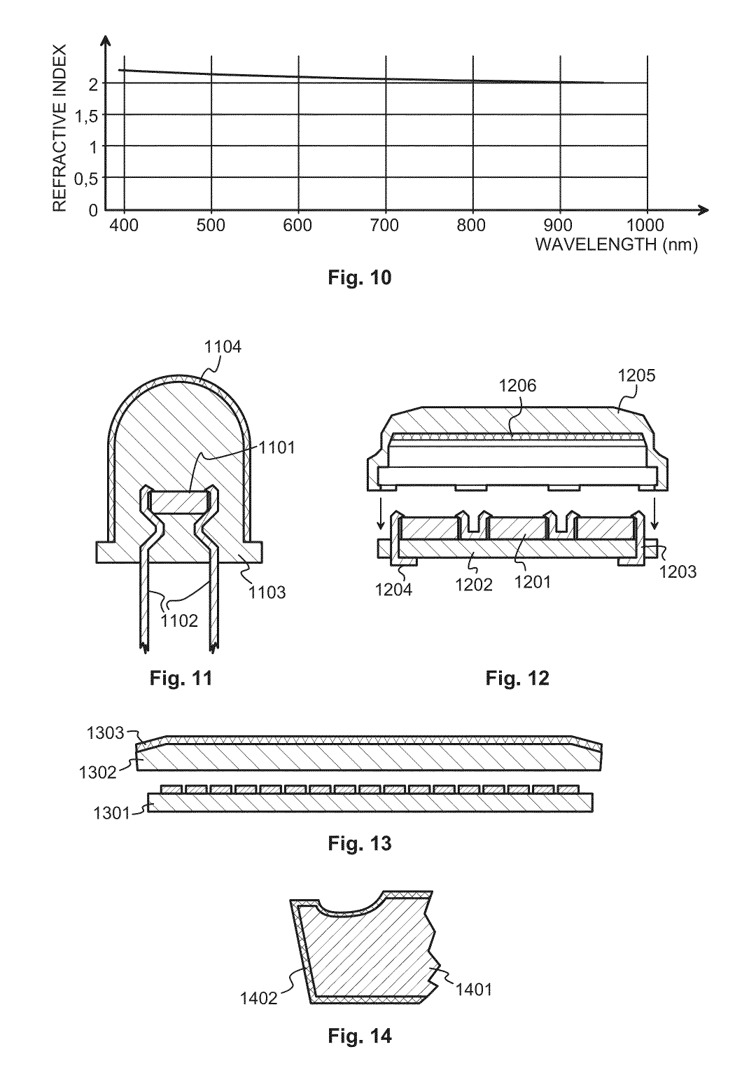

An advantageous property of a boron nitride doped carbon nitride coating according to the invention is its relatively high optical refractive index. FIG. 10 shows a graph for a measured refractive index. In this case the coating was produced on a silicon substrate by means of cold ablation using a target containing 25% by weight of boron nitride and 75% by weight of carbon nitride. The Figure shows that the refractive index is over 2 throughout the visible light wavelength range. At a wavelength of 632.8 nanometres, often used as a reference, the refractive index was measured to be 2.0702. In many applications where the optical properties of a coating are of significance, the refractive index is expected to be at least 1.7 in visible light wavelengths so that the differences between the refractive indexes of the various parts of the structure be as small as possible or in the right order (the higher and lower refractive indexes successively in the right order). The refractive index of a boron nitride doped carbon nitride coating according to the invention can be adjusted by changing the proportion of the boron nitride doping and/or process parameters.

Another boron compound that can be used as a dopant in carbon nitride is boron carbide. It is a carbonaceous compound characteristically containing a lot of sp3-type bonds so it can be used to produce similar UV-induced red-end fluorescence as nanodiamond doping. Since boron carbide, unlike boron nitride, does not contain nitrogen, it may be difficult, using boron carbide as such, to achieve those advantageous properties of a doped coating that are resulting from the presence of nitrogen. However, it is possible to achieve nitrogen-enriched boron carbide doping in such a manner e.g. that the target contains carbon nitride and boron carbide and, for the duration of the coating process, gaseous nitrogen is injected into the coating chamber emptied of air.

Exemplary coatings were produced using pulsed laser deposition from a target that contained carbon nitride doped with boron carbide. The thickness of the deposited coatings varied between 150 and 1642 nm, and all of them exhibited pencil hardness exceeding value 10. The refractive index of the coatings varied between 1.58 and 1.86. All these exemplary coatings were darkish in color.

A CBN composite coating according to an embodiment of the invention will produce different photoluminescent radiation depending on the sp2/sp3 ratio of the amorphous coating. The intensity of the light generated is in a very surprising manner strongly dependent on the surface roughness of the coating. The rougher the structure of the coating, the higher the intensity of the light generated.

The proportions by weight of carbon nitride and boron compound in the target material may be, respectively, 98% and 2%; or 95% and 5%; or 80% and 20%; or 50% and 50%; or 25% and 75%, for example. In general it can be said that the dopant is boron nitride and/or boron carbide the atomic fraction of which is 10-90% in the coating material, whereby the atomic fraction of carbon nitride is 10-90% in the coating material.

In an advantageous embodiment of the invention, the use of a boron compound or compounds as a dopant in a target and the making of the coating by means of cold ablation cause the coating thus produced to contain boron, carbon and nitrogen in the form of a so-called BC2N phase which may appear in an amorphous, micro-crystalline (crystalline nano- and/or microparticles in an otherwise amorphous phase) or crystalline state. The term BC2N phase is used for a superphase the existence of which has been predicted by calculations (see e.g. Chunqiang Zhuang, Jijun Zhao, Xin Jiang: poster presentation “Searching superhard cubic phases in B—CN system by first-principle calculations”, Institute of Materials Engineering, Chair of Surface and Materials Technology, University of Siegen, http://www.mb.uni-siegen.de/e/lot/, published at the Diamond 2011 conference in Garmisch-Partenkirchen 4-8 Sep 2011.

A carbon nitride target doped with a boron compound can be manufactured with the same method as a carbon nitride target doped with nanodiamonds, i.e. compacting a mixture containing pulverised carbon nitride and pulverised boron compound well mixed in suitable percentages. As a carbon nitride target can be doped using different amounts of boron nitride and/or boron carbide, the invention enables completely new, previously unknown CBN compositions and their advantageous use in various applications.

Carbon Nitride Doped with Hydrogen

Chemical vapour deposition (CVD) method can be used for producing a diamond-like carbon (DLC) coating. If only (graphitic) carbon is used as a raw material for the coating, the coating will be hard, but its friction properties typically are modest and the surface will not be very uniform. With CVD, it is possible to add 8-12 per cent by weight of hydrogen to the DLC coating whereby the surface will be more uniform and the friction properties will be better.

Graphitic carbon nitride has a planar crystal structure because carbon atoms form a certain number of double bonds with nitrogen atoms so that the structure becomes of the sp2 type and there are few inter-atom bond directions free from the plane outwards. Addition of hydrogen to graphitic carbon nitride results in that some of the double bonds relax into single bonds as some of the carbon atoms become bonded with one hydrogen atom. As some of the double bonds become saturated the structure becomes more integrated and compact. Single bonds do not limit the bonding directions in the same way as double bonds so that more inter-plane bonds may start to appear in the crystal structure and the structure begins to turn increasingly into an sp3-type structure. Doping with hydrogen thus has the effect that, strictly speaking, we can no longer refer to this material as graphitic carbon nitride.

To put it in somewhat simple terms, we can say that the addition of hydrogen at the crystallisation stage of carbon nitride contributes to the formation of a stable three-dimensional crystal structure. If by crystallisation stage we mean the adherence of plasma—cold ablated from a carbon nitride target—and generation of a coating on a surface of a substrate, the three-dimensional nature of the crystal structure helps to produce an extremely uniform coating. The addition of hydrogen to carbon nitride results in an UV-induced fluorescent light redder than what is obtained from a pure carbon nitride coating. Additionally, the relaxing effect of hydrogen which favours a three-dimensional crystal structure may increase the transmittance of the coating in the visible light wavelength range. Furthermore, the relaxing effect of hydrogen which favours a three-dimensional crystal structure improves the diffusion blocking properties of the coating since a coating containing a high proportion of three-dimensional crystal structure is, from the diffusion standpoint, more tight than a coating formed of planar two-dimensional structures.

According to an embodiment of the invention a coating is produced so that the basic material of the coating is carbon nitride to which 1-12 per cent by weight of hydrogen is added in the coating process. One method for producing a hydrogen-doped carbon nitride coating is cold ablation where the target is made of carbon nitride, air is pumped out of the coating chamber and, then, gaseous hydrogen is injected into the coating chamber. The partial pressure of the hydrogen in the chamber and its relationship with the laser power, pulse length, pulse frequency, spot size, scanning speed and other process parameters can be used to control how much hydrogen the coating will have in it.

Carbon Nitride Doped with Other Materials

Doping of carbon nitride with an alkali metal, rare earth metal and/or alkaline earth metal will result in a coating with fluorescence and/or chromatographic properties typical of that dopant. Such a dopant could be cerium, europium, samarium, neodymium, praseodymium, erbium, ytterbium, holmium or terbium, for instance. If an alkali metal, rare earth metal or alkaline earth metal is used, typically its proportion in the target material is 1-30% or even under 1% by weight.

Graphitic carbon, amorphous carbon and pyrolytic carbon are almost inevitably present as dopants in all coatings produced from a carbon nitride target through laser ablation because some of the carbon atoms in the ablation-induced plasma will, as they solidify, produce these various allotropic forms of carbon. By choosing a suitable target material and suitable process parameters a result can be achieved where the coating contains as a dopant a mixture of graphitic, amorphous or pyrolytic carbon and nanodiamonds.

Some coatings made of doped carbon nitride may be hydrophilic to such an extent that the coating comes off the substrate as it absorbs too much water from the atmosphere. The hydrophilicity of a coating can be reduced (i.e. its hydrophobicity increased) by using a fluoropolymer as a dopant, one especially advantageous such dopant being polytetrafluoroethylene. The use of a fluoropolymer or -polymers as a dopant may also improve the dirt-repelling properties of the coating, reduce its friction and increase its wear resistance. It has been found that a fluoropolymer added in small quantities into a carbon nitride coating is not as sensitive to heat as a fluoropolymer as such. Good thermal conductivity of the carbon nitride material has a positive effect on the heat resistance of a carbon nitride coating doped with a fluoropolymer in accordance with the invention.

Versatility achieved through the use of fluoropolymers in coating materials is so high that, generally speaking, in a coating material according to an embodiment of the invention, the atomic fraction of the fluoropolymer dopant is 1-99% of the coating material, whereby the atomic fraction of the carbon nitride is 1-99% of the coating material.

Exemplary coatings were deposited on silicon and glass substrates using carbon nitride doped with 5% wt. PTFE (polytetrafluorethylene) as the coating material. Thicknesses of the deposited coatings varied between 150 and 490 nm. Optical transmittance was measured from the coatings deposited on glass, and was found to be approximately 90% at visible light wavelengths. The pencil hardness of the coatings was measured both from samples deposited on silicon and from samples deposited on glass, and was found to exceed value 9 in all cases. The measured contact angle for water exceeded 160 degrees. The deposited films exhibited excellent adhesion.

Other exemplary coatings were deposited on silicon and glass substrates using a target that consisted of carbon nitride and PTFE in the relation 20:80% per weight. Thicknesses of the deposited coatings varied between 100 nd 1860 nm. The measured contact angle for water exceeded 160 degrees. The deposited films exhibited excellent adhesion.

All carbon nitride dopants and doping methods discussed in this description are mutually combinable. For instance, although the ternary diagram in FIG. 5 describes the mutual proportions of only three specific elements in the coating, that does not mean there could not be other materials in the coating in addition to those three. For example, it is possible to produce a coating with very good visible light transmitting properties by doping carbon nitride with boron nitride, at the same time achieving sufficient hydrophobicity for the coating by using a fluoropolymer as another dopant and, furthermore, control the cromatographic and/or fluorescence properties of the coating by using a rare earth metal, such as cerium, europium, samarium, neodymium, praseodymium, erbium, ytterbium, holmium or terbium as a dopant as well. Different dopants can be used homogeneously throughout the coating or layers and/or regions could be formed in the coating with different dopant contents in them.

### LED Component and LED Component Casing

FIG. 11 schematically shows a LED component containing a semiconductor chip 1101 with a p-n junction in it, wires 1102, and a moulded plastic housing 1103 the function of which is to shield the electric parts and guide the electromagnetic radiation induced in the p-n junction by an electric current of a suitable type. This generation of electromagnetic radiation is called electroluminescence. The plastic housing 1103 may also be called a casing for the LED component, although in this case it is a fixed and inseparable part of the LED component itself.

FIG. 12 schematically shows a LED component in which a plurality of semiconductor chips 1201 are attached to a common substrate 1202. Wires 1203 provide the necessary electrically conductive connections between the semiconductor chips 1201 and from the semiconductor chips 1201 to coupling pads 1204 on the bottom surface of the substrate 1202. A LED component casing 1205 made of plastic or rubber (silicone rubber, for example) can be attached onto an entity consisting of a substrate 1202, semiconductor chips 1201, wires 1203 and coupling pads 1204 so that in the complete LED component the LED component casing 1205 covers the semiconductor chips 1201, shields the electric parts of the LED component and guides the electromagnetic radiation generated in the p-n junctions of the semiconductor chips 1201 as a result of an electric current of a suitable type.

An individual LED component may also have two or more LED component casings (on top of one another or overlapping, for example) or an individual LED component casing in a complete assembly may cover two or more LED components. The shapes and structures of the LED components and their casings shown in FIGS. 11 and 12 are just examples of numerous different alternatives and do not exclude the application of the present invention to LED components of other types or to LED component casings of other types.

A given p-n junction emits electromagnetic radiation only at a certain wavelength determined by the width of the energy gap of the semiconductor material. LED components can be used to produce a light of a different colour as well, but this requires the simultaneous use of a plurality of semiconductor chips that have energy gaps of differing widths or a fluorescent conversion material around the semiconductor chip.

FIG. 11 schematically shows a coating 1104 on an outer surface of a plastic housing 1103 where the outer surface is the one that faces the primary viewing direction of the light produced by the LED component. The material(s) of the semiconductor chip 1101 are chosen such that electroluminescence will produce ultraviolet or near-ultraviolet radiation (i.e. radiation that has a shorter wavelength than at least the majority of visible light). The coating 1104 contains one or more fluorescent material(s) excited by the radiation produced by the semiconductor chip 1101, and emitting, as the excited state decays, visible light at the desired wavelength(s).

Similarly, FIG. 12 schematically shows a coating 1206 which in this instance is located on the inner surface of the LED component casing 1205. The idea is the same as in FIG. 11, i.e. the shorter-wave electromagnetic radiation produced through electroluminescence by the semiconductor chips 1201 is converted in the coating 1206 through fluorescence into visible light at the desired wavelength(s). In addition to or instead of the coating solutions shown in FIGS. 11 and 12 it is also possible to mix a fluorescent substance in the material which the LED component casings is made of.

A fluorescent LED component is known as such, but prior-art solutions have often been forced to use fluorescent substances which may be difficult to obtain or the handling of which involves risks or possible disadvantages. Typically, in prior-art LED components, rare earth metals are needed in order to achieve a desired colour for the fluorescent light. Such earth metals must be excavated and, at the time of writing, 90% of their production comes from China. As the supply of earth metals is limited, a global, cost-efficient and ecologically sustainable adoption of LED components requires new fluorescence solutions that are based on widely available, preferably harmless elements.

According to an embodiment of the present invention a coating containing doped carbon nitride is used in a LED component and/or LED component casing. For example, carbon nitride doped with nanodiamonds and/or boron carbide, under ultraviolet irradiation, emits fluorescent radiation at a visible light wavelength range so wide that the fluorescent radiation can be said to be white light. In the absence of such a stimulant, carbon nitride doped with nanodiamonds may appear dark grey, for example, to the human eye, which means such a coating can be used to produce interesting and exciting contrasts depending on whether the coated LED component is on or off.

### Optical Component

FIG. 13 schematically shows a display element 1301 shielded by an optical component 1302. In this case the optical component 1302 is just a shield the function of which is to allow the viewing of an image, text or such shown on the display 1301 from the primary viewing direction, which in the case of FIG. 13 is up. In addition, the shield 1302, as its name suggests, shields the display 1301 against touching and other external impacts. Such shields are typically made of transparent plastics or glass and are used in all kinds of electronic devices, such as portable communication devices, TV sets, computer displays, household appliances, vehicles, toys and so forth. Other widely used optical components include various lenses (such as eyeglass lenses), mirrors and prisms.

Inexpensive transparent plastics, such as polycarbonate, are often relatively soft and easily scratched and may have other properties, too, which are disadvantageous in optical components. As such, it is known to use various coatings in optical components e.g. in order to improve the wear resistance of a surface, reduce unwanted reflections or make cleaning easier.

FIG. 13 schematically shows a coating 1303, made of doped carbon nitride, of an optical component. Several very advantageous properties can be achieved by choosing a correct dopant or correct dopants. For example, a carbon nitride coating doped with boron nitride is highly transparent at visible light wavelengths and considerably harder than many raw materials commonly used for optical components so it can be used to significantly improve the wear resistance of a surface of an optical component. Fluoropolymer doping can be used to introduce lipophobicity in a coating in order to reduce the adherence of grease onto a surface, thereby reducing the occurrence of visible fingerprints (anti-fingerprint property). Wavelength selectivity and/or a desired type of fluorescence can be introduced in a coating by using one or more rare earth metals, alkali metals or alkaline earth metals as dopants.

### Casing

FIG. 13 was above described particularly from the standpoint of an optical component but many of the ideas discussed above can be directly generalised to apply to parts of device casings for which transparency or other optical properties are not primary requirements. According to an embodiment of the invention, a coating can be produced for the casing part of a portable or another kind of device, where visible fingerprints are unwanted or, more generally, the casing part should be dirt-repellent and/or easy to clean.

### Machine Tool

In machining, good cutting ability and resistance to wear are important and sought-after properties in a machine tool. These can be improved by coating the tool or at least the most critical areas of its cutting edge, or blade, with a coating that has a good adhesion to the material of the tool or blade, is suitably hard and has advantageous tribological properties.

FIG. 14 schematically shows a cross section of a cutting edge of a machine tool, in this case a lathe. The cutting edge material 1401 is coated with doped carbon nitride coating 1402 at least for the parts that come into contact with the material machined. The coating could be a boron nitride doped carbon nitride coating produced on a heated substrate (the cutting edge material), in which case it could have a hardness of up to 10H on the pencil hardness scale. In addition to or instead of boron nitride as a dopant in the carbon nitride, nanodiamonds, other allotropic forms of carbon, boron carbide, hydrogen, nitrogen or a fluoropolymer could be used as dopant(s) in the carbon nitride.

### Examples of Constituent Materials

Component constituents that were used in experiments for verifying the industrial applicability of embodiments of the invention were following:

Carbon nitride powder, commercially available from Carbodeon Ltd Oy, Finland
chemical purity ≧99.7 wt. %
primary particle size <30 microns, agglomerated
chemical stability in inert atmosphere up to 650° C.
moisture contents ≧4 wt. %.

Boron nitride powder, commercially available from Goodfellow Corporation, USA
chemical purity >99.5 wt. %
max primary particle size 10 microns, agglomerated
moisture sensitive.

Boron carbide powder, commercially available from H. C. Starck GmbH, Germany
B:C ratio 3.7-3.8
primary particle size distribution: d50=0.6−1.2 microns, agglomerated
specific surface area: 15-20 m²/kg.

Nanodiamond powder, grade uDiamond Molto Nuevo, commercially available from Carbodeon Ltd Oy, Finland
nanodiamond content in solid state >97%
primary particle size 4-6 nm, the powder agglomerate size ranging to several tens of microns
moisture content around 2 wt. %
bulk density around 0.5 g/cm³
specific surface area >300 m²/g.

Nanodiamond powder, grade uDiamond Blend Nuevo, commercially available from Carbodeon Ltd Oy, Finland
nanodiamond content in solid state >50 wt. %, the rest being substantially amorphous and graphitic carbon
primary particle size 4-6 nm, the powder agglomerate size ranging to several tens of microns
moisture content around 1 wt. %
bulk density around 0.5 g/cm³
specific surface area >300 m²/g.

Solid fluoropolymer (polytetrafluorethylene, PTFE) powder, commercially available from numerous providers
primary particle size 6-9 microns, agglomerated
moisture content around 0.01 wt. %.

### Examples of Processing Steps

Typical initial materials come in their agglomerated form, not in their primary particle size. Additionally they exhibit different moisture absorption capacity. The agglomeration strength is high within each material, and they can possess poor affinity to each other, making it difficult to break the agglomerates and obtain an even distribution in a composite coating material. As a pre-processing step of the mixture, ball milling with 1 cm alumina or zirconia beads is advantageously performed for some time, for example 15-30 minutes.

Also, different constituent materials exhibit different affinity to moisture. It would be advantageous to exclude moisture from the target material to as large extent as possible. If sintering is used in preparing the target, unwanted moisture brought into the process within a constituent material may cause severe cracking or even damage the sintering mold through an explosion. Thus as another pre-processing step of the mixture it is advantageous to include a drying step, for example in a drying oven at the temperature of 150 degrees centigrade for several hours or overnight.

Sintering includes heating. If the heating takes place too rapidly, trace moisture (if any) in the constituent materials may evaporate in an uncontrolled way, possibly causing cracking. Also the maximum temperature must be selected carefully, in order not to cause decomposition of any of the constituent materials by overheating, but to simultaneously ensure that a required density of the eventual target (i.e. coating) material is achieved and that the required sintering time remains reasonable.

For carbon nitride composites doped with a dopant selected from nanodiamonds, boron nitride, and/or boron carbide, the following exemplary parameter values have been found workable:
sintering pressure: 75 MPa
heating rate: 50° C. per minute
sintering temperature: 500° C.
total sintering time: 15 minutes.

Fluoropolymers are more sensitive to heat than the dopants mentioned above, making sintering temperatures in the order of 500° C. unthinkable. The sintering temperature has an important effect on the density of the eventual sintered product, so it has been regarded as questionable, whether a sufficiently dense target (i.e. coating) material can be produced at all by sintering if a fluoropolymer is used as a dopant. However, it has been found that the following parameter values are workable when the dopant is PTFE:
sintering pressure: 75 MPa
heating rate: 50° C. per minute
sintering temperature: 500° C.
total sintering time: 15 minutes.

### Examples of Coating Material Constitutions

The following exemplary coating materials have been produced and tested, with the announced amounts being percentages per weight:

Carbon nitride: boron nitride targets:
Carbon nitride:Boron nitride; 95:5
Carbon nitride:Boron nitride; 90:10
Carbon nitride:Boron nitride; 75:25
Carbon nitride:Boron nitride; 50:50
Carbon nitride:Boron nitride; 75:25
Carbon nitride:Boron nitride; 95:5

Carbon nitride: boron carbide targets:
Carbon nitride:Boron carbide; 98:2
Carbon nitride:Boron carbide; 95:5
Carbon nitride:Boron carbide; 90:10
Carbon nitride:Boron carbide; 75:25
Carbon nitride:Boron carbide; 50:50
Carbon nitride:Boron carbide; 75:25
Carbon nitride:Boron carbide; 95:5

Carbon nitride: Molto Nuevo targets:
Carbon nitride:Molto Nuevo; 80:20
Carbon nitride:Molto Nuevo; 75:25

Carbon nitride: Blend Nuevo targets:
Carbon nitride:Blend Nuevo; 98:2
Carbon nitride:Blend Nuevo; 95:5
Carbon nitride:Blend Nuevo; 80:20

Carbon nitride: PTFE targets:
Carbon nitride:PTFE; 95:5
Carbon nitride:PTFE; 90:10
Carbon nitride:PTFE; 70:30
Carbon nitride:PTFE; 50:50
Carbon nitride:PTFE; 30:70
Carbon nitride:PTFE; 90:10
Carbon nitride:PTFE; 95:5

### Examples of Measured Photoluminescence

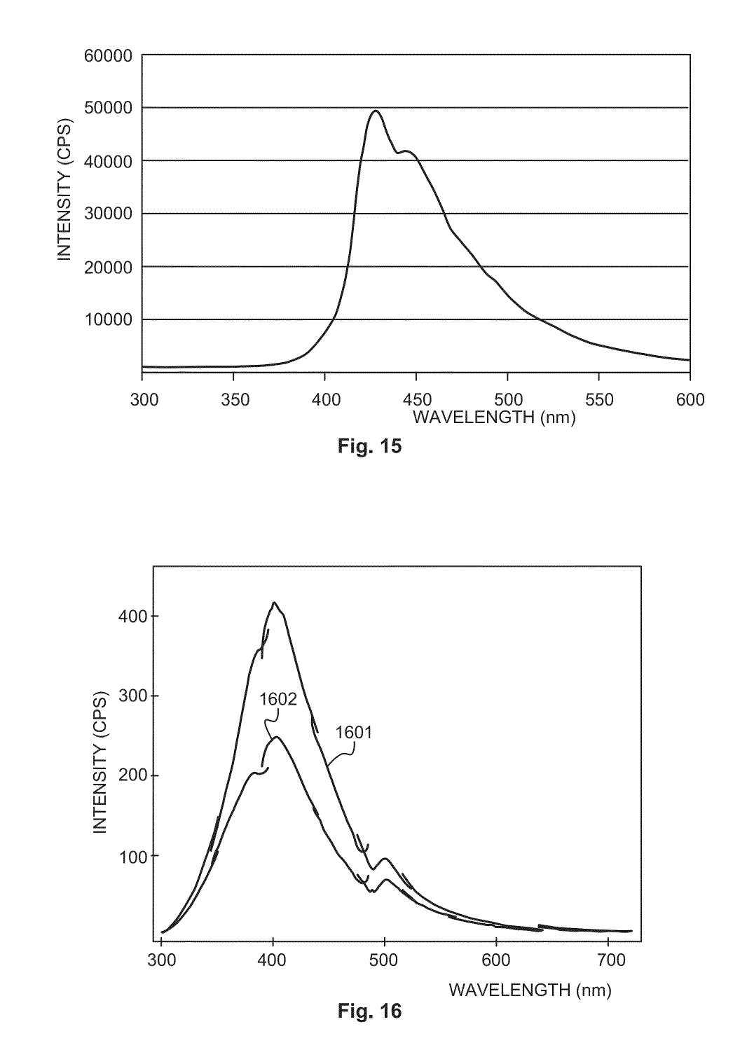

FIG. 15 illustrates the measured photoluminescence of undoped carbon nitride in powdery form, using laser light at 244 nm as the excitation signal. FIG. 16 illustrates the measured photoluminescence of two coatings that have been made with pulsed laser deposition from a target according to an embodiment of the invention, which contained carbon nitride C₃N₄ doped to 5% per weight with nanodiamonds of the Blend Nuevo grade mentioned earlier. Each of the curves 1601 and 1602 in FIG. 16 appears to consist of consecutive partial curves due to the selected measurement technique. The difference between the curves 1601 and 1602 is in the different morphology of the corresponding coatings, which in turn was achieved with different process parameters. The coating that gave curve 1601 was produced on a substrate that was held at a temperature between 336 and 365 degrees centigrade, at a distance 8 mm from the target, while the coating that gave curve 1602 was produced on a substrate that was held at a temperature of 300 degrees centigrade, at a distance 15 mm from the target.

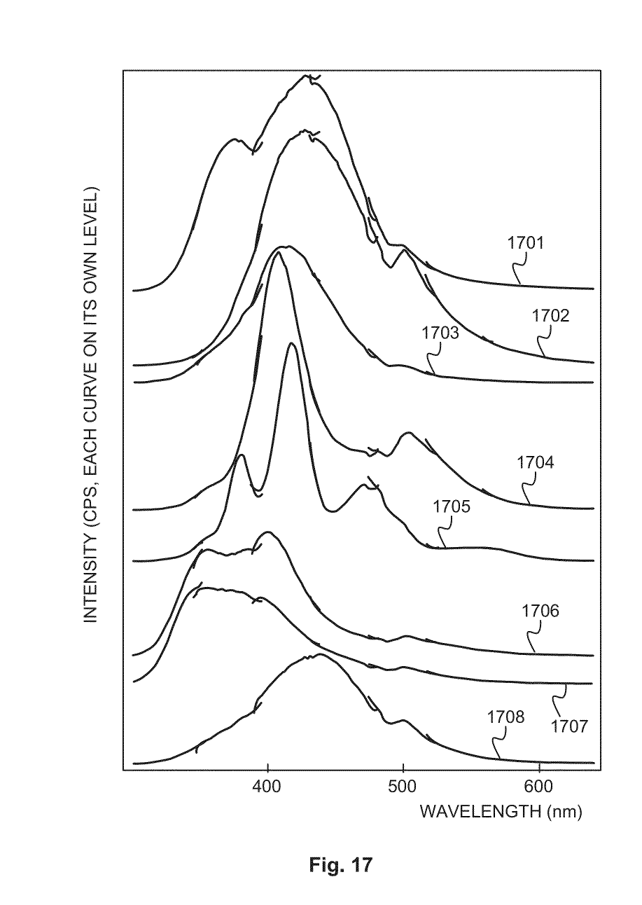

FIG. 17 illustrates the measured photoluminescence of a number of coatings that have been made with pulsed laser deposition from targets according to embodiments of the invention, which contained carbon nitride C₃N₄ doped to between 5% and 25% per weight with boron nitride. Each curve in FIG. 17 appears to consist of consecutive partial curves due to the selected measurement technique. The curves have been shifted on the vertical axis so that no curve intersects another. The zero point (measured luminescence zero CPS) for each curve is on the level of the left end of that curve. The vertical scale of each of the curves 1701 to 1707 is the same, whereas curve 1708 has been scaled eightfold to make its features more clearly visible in the drawing.

The differences between the coatings that gave the different curves in FIG. 17 come partly from the different percentage of boron nitride in the coatings, and partly from the different surface morphology that is a consequence of the different process parameter values used. Curves 1702, 1703, and 1707 came from coatings with 5% wt. of boron nitride; curves 1701, 1704, 1705, and 1708 came from coatings with 10% wt. of boron nitride, and curve 1706 came from a coating with 25% of boron nitride. In the cases of curves 1702, 1703, 1706, and 1707 the substrate was held at room temperature, and at 10 mm from the target. In the cases of curves 1701, 1704, 1705, and 1708 the distance was 20 mm, and the substrate was held at 200, 200, 100, and 300 degrees centigrade respectively.

The photoluminescence spectra of FIGS. 16 and 17 show that the dominant color content of photoluminescence changes as the composition of the coating varies, and that the intensity of photoluminescence can be adjusted by selecting the process parameter values, which in turn affect the surface morphology of the coating. In general, the larger the surface roughness (i.e. the larger is the specific surface area of the coating), the higher the intensity of the photoluminescence. The last-mentioned is an important conclusion, because previously it has been customary to evaluate the quality of a coating in terms of how smooth it is. Indeed, if only the process parameter values are selected appropriately, cold ablation is known to be capable of producing extremely smooth coatings, with few or no particulates and/or pinholes in the coating. However, as is shown here, it is advantageous that a coating produced by cold ablation does not necessarily need to be extremely smooth; in some applications, a relatively large surface roughness value is an asset rather than a drawback.

1. A coating material for coating a substrate by means of laser ablation, wherein:
the coating material contains graphitic carbon nitride and a dopant in order to alter the properties of the coating produced as compared to pure carbon nitride
the density of the coating material is at least 70% of the theoretical density of the coating material and
the grain size of the dopant in the coating material is not more than 30 micrometres.

2. A coating material according to claim 1, wherein the dopant contains nanodiamonds.

3. A coating material according to claim 2, wherein the percentage by weight of nanodiamonds in the coating material is 1-50%.

4. A coating material according to claim 3, wherein the percentage by weight of nanodiamonds in the coating material is 1-20%.

5. A coating material according to claim 4, wherein the percentage by weight of nanodiamonds in the coating material is 1-10%.

6. A coating material according to claim 1, wherein the dopant contains a boron compound, which comprises at least one of: boron nitride, boron carbide.

7. A coating material according to claim 6, wherein the atomic fraction of the boron compound used as a dopant is 10-90% of the coating material, and the atomic fraction of carbon nitride is 10-90% of the coating material.

8. A coating material according to claim 1, wherein the dopant contains a fluoropolymer.

9. A coating material according to claim 8, wherein the atomic fraction of the fluoropolymer used as a dopant is 1-99% of the coating material, and the atomic fraction of carbon nitride is 1-99% of the coating material.

10. A coating containing carbon nitride produced from a target by means of laser ablation, wherein the coating contains a dopant for altering the properties of the coating as compared to a coating of pure carbon nitride.

11. A coating according to claim 10, wherein the dopant contains nanodiamonds.

12. A coating according to claim 11, wherein the percentage by weight of nanodiamonds in the coating is 1-50%.

13. A coating according to claim 12, wherein the percentage by weight of nanodiamonds in the coating is 1-20%.

14. A coating according to claim 13, wherein the percentage by weight of nanodiamonds in the coating is 1-10%.

15. A coating according to claim 11, wherein sp3-type crystalline regions originating from nanodiamonds in the target material form nucleation centres surrounded by carbon nitride portions in the coating where sp3-type bonds are more common than in carbon nitride in general.

16. A coating according to claim 10, wherein the dopant contains a boron compound, which comprises at least one of: boron nitride, boron carbide.

17. A coating according to claim 16, wherein the atomic fraction of the boron compound used as a dopant is 10-90% of the material of the coating, and the atomic fraction of carbon nitride is 10-90% of the material of the coating.

18. A coating according to claim 16, comprising boron, carbon and nitrogen in the form of a BC2N phase.

19. A coating according to claim 10, wherein the dopant contains hydrogen.

20. A coating according to claim 10, wherein the dopant contains at least one of: graphitic carbon, amorphous carbon, pyrolytic carbon.

21. A coating according to claim 10, wherein the dopant contains a mixture of nanodiamonds with at least one of: graphitic carbon, amorphous carbon, pyrolytic carbon.

22. A coating according to claim 10, wherein the dopant contains a fluoropolymer.

23. A coating according to claim 10, wherein the dopant contains at least one of: a rare earth metal, an alkali metal, an alkaline earth metal.

24. A coated object, wherein a material of a coating on the object contains graphitic carbon nitride and a dopant for altering the properties of the coating as compared to a coating of pure carbon nitride.

25. A coated object according to claim 24, wherein the dopant contains nanodiamonds.

26. A coated object according to claim 24, wherein the dopant contains a boron compound, which comprises at least one of: boron nitride, boron carbide.

27. A coated object according to claim 24, wherein the dopant contains hydrogen.

28. A coated object according to claim 24, wherein the dopant contains at least one of: graphitic carbon, amorphouos carbon, pyrolytic carbon

29. A coated object according to claim 24, wherein the dopand contains a mixture nanodiamonds with at least one of: graphitic carbon, amorphous carbon, pyrolytic carbon.

30. A coated object according to claim 24, wherein the dopant contains a fluoropolymer.

31. A coated object according to claim 24, wherein the dopant contains at least one of: a rare earth metal, an alkali metal, an alkaline earth metal.

32. A coated object according to claim 24, wherein said coated object is a machine tool.

33. A coated object according to claim 32, wherein the coating of the machine tool contains boron, carbon and nitrogen in the form of a BC2N phase.

34. A coated object according to claim 24, wherein said coated object is an optical element.

35. A coated object according to claim 24, wherein said coated object is a LED component.

36. A coated object according to claim 35, wherein the LED component is arranged to produce white light.

37. A coated object according to claim 24, wherein said coated object is a fluorescent casing of a LED component.

38. A coated object according to claim 37, wherein the fluorescent casing of a LED component has a fluorescence spectrum substantially that of white light.
